(19) United States
(12) Patent Application Publication
(10) Pub. No.: US 2026/0339015 A1
(43) Pub. Date: Oct. 29, 2026

(54) Electronic Device with Light-Emitting Structure

(71) Applicant: Corsair Memory Inc., Milpitas, CA (US)

(72) Inventors: David Nguyen, Milpitas, CA (US); Thi La, Milpitas, CA (US); Jake Crimmins, Milpitas, CA (US); Chun Ye, Milpitas, CA (US); Sunil Daddar, Milpitas, CA (US)

(21) Appl. No.: 19/345,049

(22) Filed: Sep. 30, 2025

(30) Foreign Application Priority Data
Apr. 23, 2025 (TW) 114204063

(51) Int. Cl. F21V 8/00

(52) U.S. Cl. CPC G02B 6/005; G02B 6/0073

(57) ABSTRACT

Provided herein may be electronic device with light-emitting structure, comprising a circuit unit comprising a circuit board and a light-emitting module arranged on the circuit board; and a side panel unit comprising a side panel body arranged on the side of the circuit board, and a characteristic light-transmitting structure arranged on the side panel body, the light emitted by the light-emitting module penetrating the characteristic light-transmitting structure and being output outward.

### CROSS-REFERENCE TO RELATED APPLICATION

The present application claims priority under 35 U.S.C. § 119(a) to Taiwan Utility Model Application No. 114204063, filed on Apr. 23, 2025, which is incorporated herein by reference in its entirety.

### TECHNICAL FIELD

The present invention relates to an electronic device, and more particularly, to one that utilizes light-emitting elements to display a unique lighting function in a designated area.

### BACKGROUND

Among computer components, dynamic random-access memory (DRAM) is essential mainstream equipment for data storage, serving as temporary storage for files and data actively used while the computer runs programs or applications. With advancements in technology, not only has data processing speed increased, but overall structures have also become smaller and thinner. However, this has led to the issue of heat accumulation. To address this, existing memory devices are typically equipped with heat sinks (or heat spreaders).

The existing memory devices have the following drawbacks:
1. The sides of the heat sink cannot emit light, and the lighting effects are limited. The combination of the heat sink and light guide allows light to be emitted only around the top edge areas of the memory, and the top lighting effect is limited, typically producing a simple light strip effect.;
2. Patterns on the device cannot have a light-emitting effect;
3. The light-emitting structures on the surface cannot be replaced.

### BRIEF DESCRIPTION OF THE DRAWINGS

FIG. 1 is a perspective schematic view illustrating an electronic device with light-emitting structure according to a first embodiment of the present invention.

FIG. 2 is a schematic cross-sectional view of a partial structure using a light-concentrating structure in the first embodiment.

FIG. 3 is a schematic cross-sectional view of a partial structure using another light-concentrating structure in the first embodiment.

FIG. 4 is a partial cross-sectional schematic view illustrating an electronic device with light-emitting structure according to a second embodiment of the present invention.

FIG. 5 is an exploded perspective schematic view of the second embodiment

FIG. 6 is a schematic side cross-sectional view of the second embodiment.

FIG. 7 is an exploded perspective schematic view illustrating an electronic device with light-emitting structure according to a third embodiment of the present invention.

FIG. 8 is a schematic side cross-sectional view of the third embodiment.

FIG. 9 is a partial side schematic view illustrating an electronic device with light-emitting structure according to a fourth embodiment of the present invention.

FIG. 10 is a partial side schematic view illustrating an electronic device with light-emitting structure according to a fifth embodiment of the present invention.

FIG. 11 is a schematic side cross-sectional view illustrating an electronic device with light-emitting structure according to a sixth embodiment of the present invention.

FIG. 12 is a schematic side cross-sectional view illustrating an electronic device with light-emitting structure according to a seventh embodiment of the present invention.

FIG. 13 is a schematic side cross-sectional view illustrating an electronic device with light-emitting structure according to an eighth embodiment of the present invention.

FIG. 14 is a schematic side cross-sectional view illustrating an electronic device with light-emitting structure according to a ninth embodiment of the present invention.

FIG. 15 is a schematic side cross-sectional view illustrating an electronic device with light-emitting structure according to a tenth embodiment of the present invention.

### DETAILED DESCRIPTION

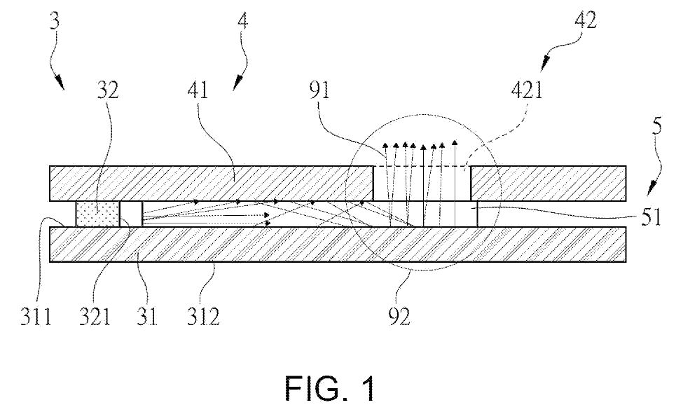

Referring to FIGS. 1-3, which illustrate an electronic device with light-emitting structure according to a first embodiment of the present invention. The electronic device with light-emitting structure comprises a circuit unit 3, a side panel unit 4, and a light guiding unit 5.

The circuit unit 3 includes a circuit board 31 and a light-emitting module 32 arranged on the circuit board 31. The circuit board 31 has a first surface 311 and a second surface 312 opposite to each other. The light-emitting module 32 is a light-emitting diode (LED) arranged on the first surface 311. In some embodiments, the light-emitting module 32 may use an omni-directional light-emitting diode, a side-fire LED, or a vertical-fire LED.

The side panel unit 4 includes a side panel body 41 arranged on the side of the circuit board 31, and a characteristic light-transmitting structure 42 arranged on the side panel body 41. One light-emitting module 32 corresponds to one characteristic light-transmitting structure 42, and the light emitted by the light-emitting module 32 passes through the characteristic light-transmitting structure 42 and is output outward. The characteristic light-transmitting structure 42 has a light-transmitting hole 421 arranged on the side panel body 41, and the light-transmitting hole 421 is a through hole that penetrates the side panel body 41.

The light guide unit 5 includes a light guide body 51 arranged between the light-emitting module 32 and the characteristic light-transmitting structure 42. In some embodiments, a socket is provided on the circuit board 31, and the light guide body 51 is arranged on the socket so that the light guide body 51 can be arranged on the side of the circuit board 31.

The light-emitting surface 321 of the light-emitting module 32 faces the characteristic light-transmitting structure 42. The light-emitting module 32 and the light guide body 51 are spaced apart so that a better reflection transmission effect can be produced inside the light guide body 51. In actual implementation, the light-emitting module 32 can also contact the light guide body 51, but the configuration should not be limited to this. In some embodiments, the side panel body 41 is a light-proof surface layer of the light guide body 51.

After the light emitted by the light-emitting module 32 enters the interior of the light guide body 51, the light is reflected in the interior of the light guide body 51 in a light direction 91, and then passes outward through the light-transmitting hole 421 of the characteristic light-transmitting structure 42.

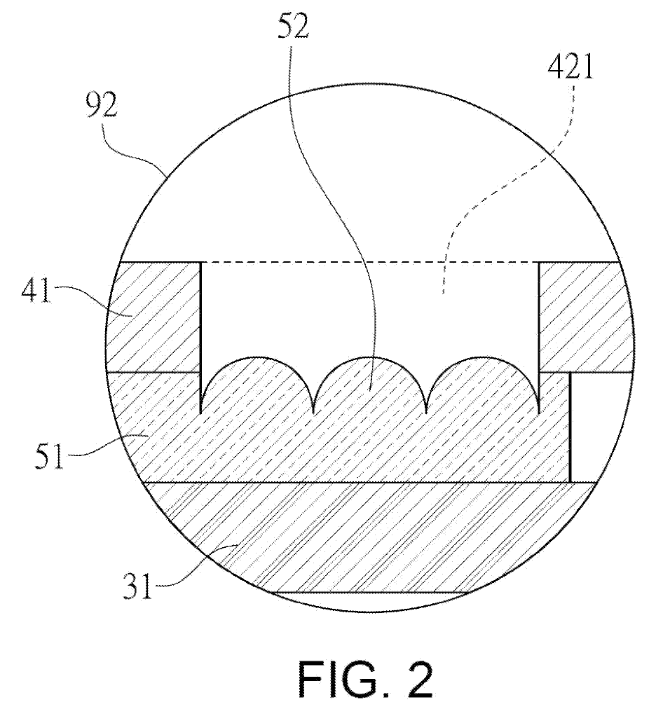

Refer to FIGS. 1 and 2, the structure of the light guide unit 5 in the characteristic light-transmitting structure 42 is shown in the local area 92. The light guide unit 5 further includes a light concentrating structure 52 arranged in the light guide body 51. The setting position of the light concentrating structure 52 corresponds to the characteristic light-transmitting structure 42. The light concentrating structure 52 is selected from one of a convex lens, a concave lens, a Fresnel lens, a groove, a perforation, a reflective layer, or a combination thereof.

In some embodiments, the light concentrating structure 52 is a plurality of convex lenses on the upper surface of the characteristic light-transmitting structure 42. The light concentrating structure 52 can refract the light transmitted from the inside of the light guide body 51, so that the characteristic light-transmitting structure 42 produces a focused lighting effect or a light well lighting effect.

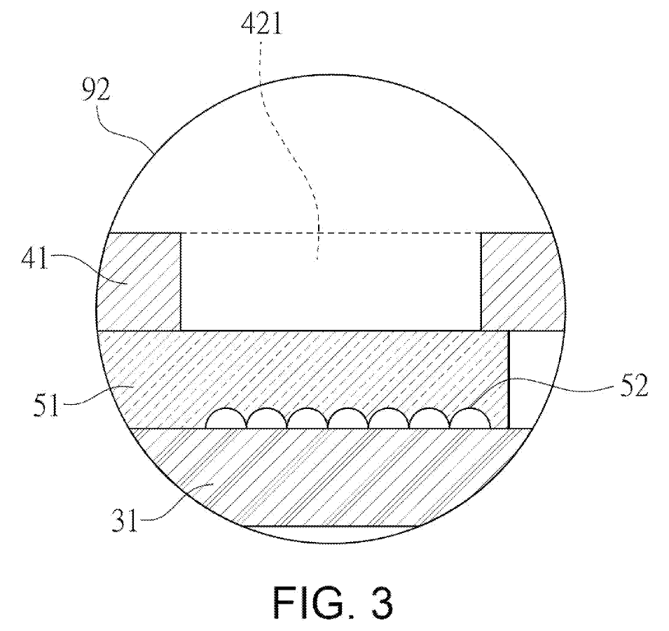

Referring to FIGS. 1 and 3, in some embodiments, the light concentrating structure 52 is a plurality of concave lenses on the lower surface of the characteristic light-transmitting structure 42. In some embodiments, the light guide body 51 is not arranged between the light-emitting module 32 and the characteristic light-transmitting structure 42.

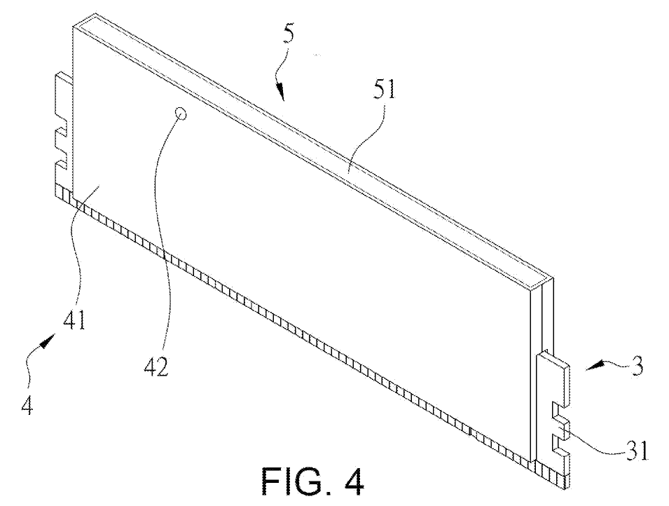

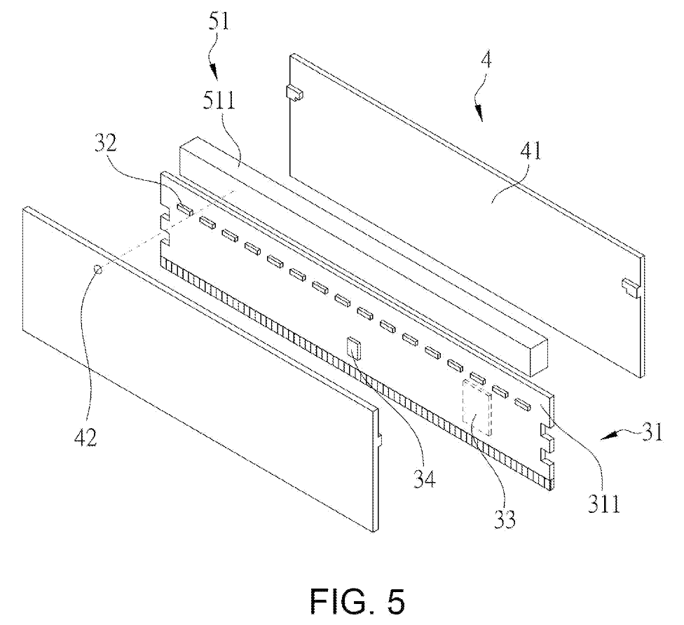

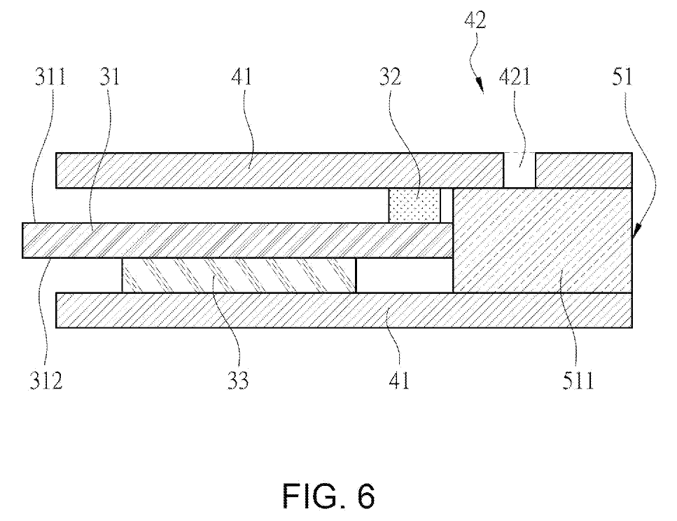

Referring to FIGS. 4-6, which illustrate an electronic device with light-emitting structure according to a second embodiment of the present invention. The second embodiment is substantially the same as the first embodiment. The difference is that the circuit unit 3 further includes a memory 33 arranged on the circuit board 31, and a light control module 34 arranged on the circuit board 31. The light control module 34 is mounted on the first surface 311, and the memory 33 is mounted on the second surface 312, but the configuration is not limited to this.

The light control module 34 is connected to the plurality of light-emitting modules 32 to control the light effects of the plurality of light-emitting modules 32. The memory 33 is a semiconductor chip for storing data, so that the present invention may become a computer component such as a dynamic memory 33 (DRAM), a dynamic memory 33 of CAMM 2, a solid-state hard disk (M.2 SSD), etc.

The side panel body 41 is a heat sink, but is not limited to this. The characteristic light-transmitting structure 42 is a small hole on the side panel body 41. The light guide body 51 is arranged on the top of the circuit board 31. The light guide body 51 has a top light guide component 511 arranged on the top edge of the circuit board 31. The light emitted by the light-emitting module 32 enters the top light guide component 511 and then passes out through the characteristic light-transmitting structure 42. In addition, the light in the top light guide component 511 will also pass out from the top of the electronic device with light-emitting structure to display a special lighting effect in a specific area on the top.

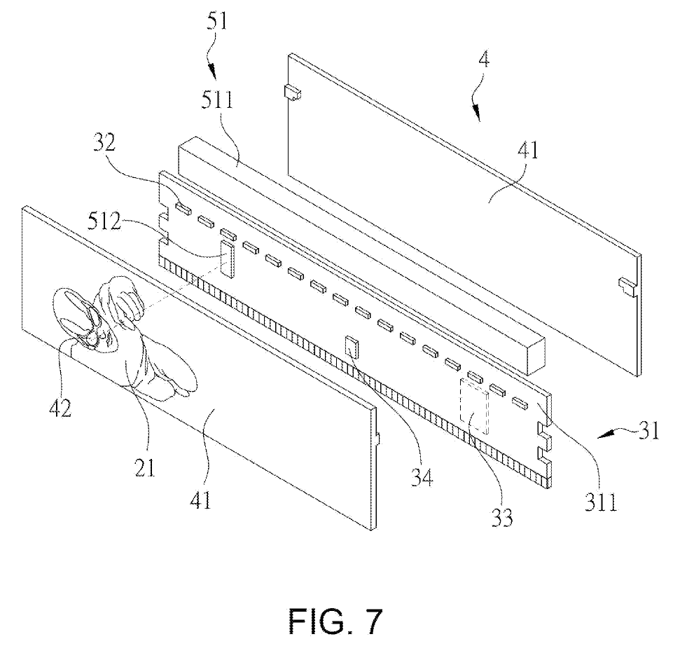

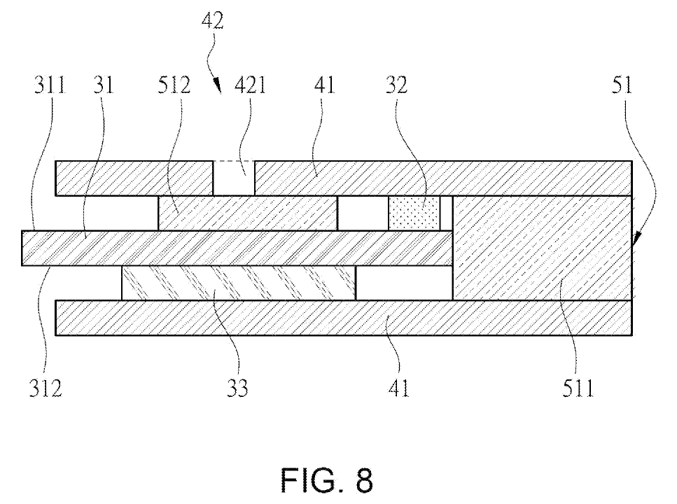

Referring to FIGS. 7-8, which illustrate an electronic device with light-emitting structure according to a third embodiment of the present invention. The third embodiment is substantially the same as the second embodiment. The difference is that the light guide body 51 is arranged on the top and side of the circuit board 31, and the light guide body 51 has a side light guide component 512 arranged on the side of the circuit board 31.

The light-emitting module 32 is spaced apart from the top light guide component 511 and the side light guide component 512, respectively. The light emitted by the light-emitting module 32 enters the top light guide component 511 and the side light guide component 512, respectively. The light inside the top light guide component 511 is transmitted outward from the top of the electronic device with light-emitting structure, and the light inside the side light guide component 512 is transmitted outward from the light-transmitting hole 421 of the characteristic light-transmitting structure 42.

The characteristic light-transmitting structure 42 is located just at the eyes of the character image 21, so that the eyes of the character image 21 can emit light, wherein the light control module 34 controls the light-emitting module 32 to emit flashing red light, so that the eyes of the character image 21 can emit flashing red light. The light guide body 51 can be made of a general light guide material or a light guide material that performs total internal reflection.

The present invention has three options for the light guide body 51 using a total internal reflection light guiding material: 1. The light guide body 51 as a whole is a total internal reflection structure; 2. An opening is set in the structure of the light guide body 51 to allow light to directly penetrate; 3. The light guide body 51 structure is not only provided with an opening, but also a light guide body 51 that can focus and/or reflect light is set at the opening, such as a concave lens, a convex lens, a reflector, etc., which can optimize the light distribution and enhance the visual effect structure.

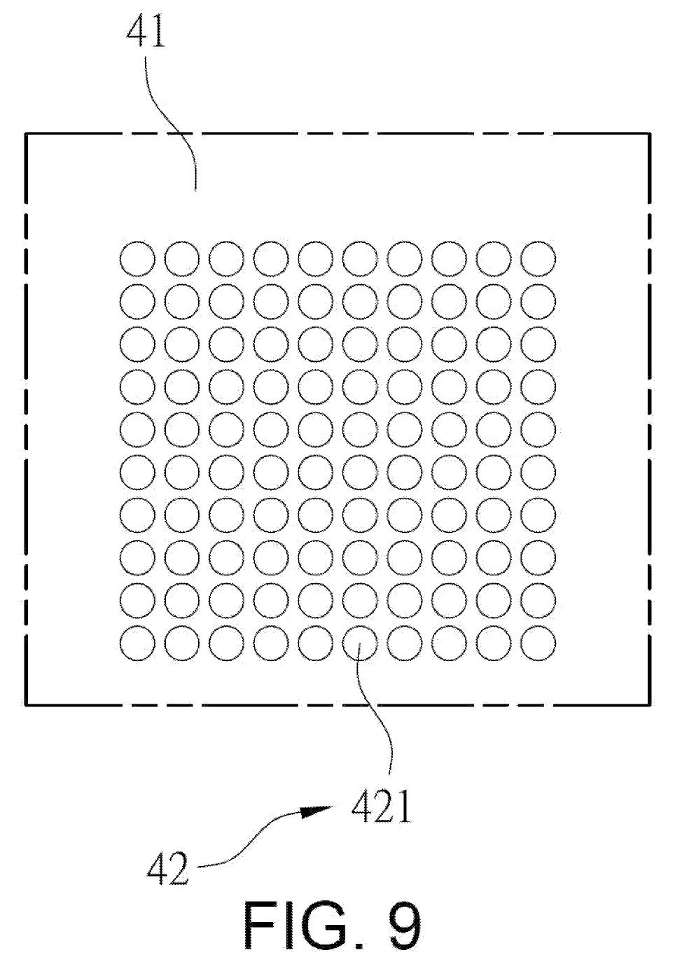

Referring to FIG. 9, which illustrate an electronic device with light-emitting structure according to a fourth embodiment of the present invention. The fourth embodiment is substantially the same as the first embodiment. The difference is that the characteristic light-transmitting structure 42 has a plurality of light-transmitting holes 421 arranged on the side panel body 41, and the apertures of the plurality of light-transmitting holes 421 are consistent.

The structure of the plurality of light-transmitting holes 421 is a micro-drill hole. The plurality of light-transmitting holes 421 are arranged in a matrix. The aperture of the plurality of light-transmitting holes 421 is less than 1 mm.

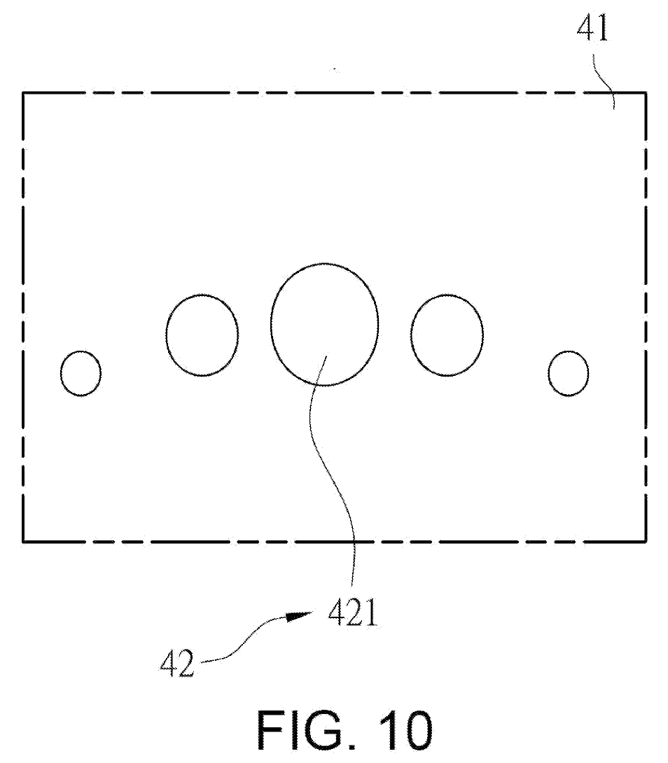

Referring to FIG. 10, which illustrate an electronic device with light-emitting structure according to a fifth embodiment of the present invention. The fifth embodiment is substantially the same as the first embodiment. The difference is that the characteristic light-transmitting structure 42 has a plurality of light-transmitting holes 421 arranged on the side panel body 41, and the apertures of the plurality of light-transmitting holes 421 are not consistent. The aperture of the plurality of light-transmitting holes 421 is between 1 mm and 2 mm.

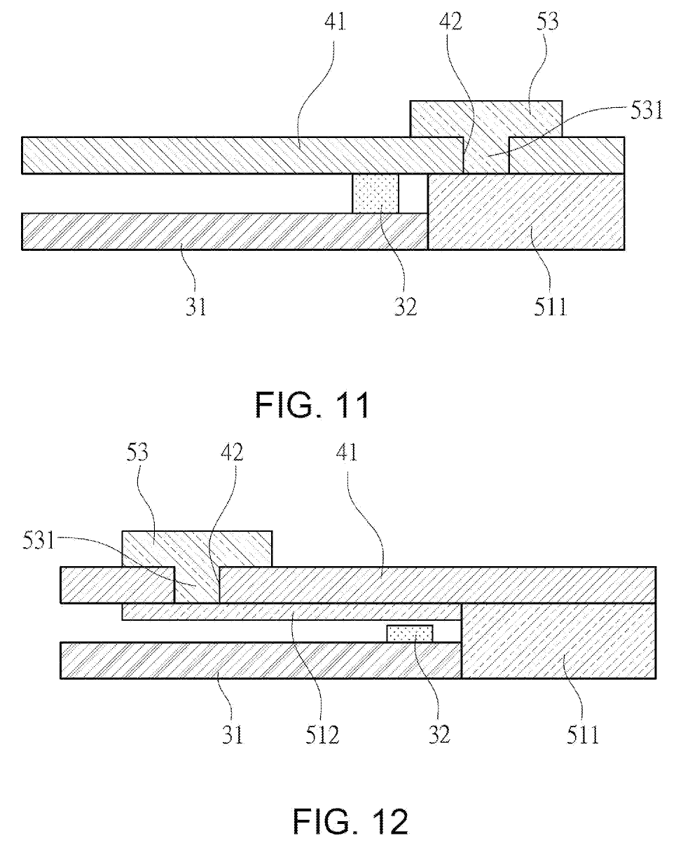

Referring to FIG. 11, which illustrate an electronic device with light-emitting structure according to a sixth embodiment of the present invention. The sixth embodiment is substantially the same as the second embodiment. The difference is that the light guide unit 5 includes a characteristic assembly body 53 which can be detachably assembled with the characteristic light-transmitting structure 42. The light emitted by the light-emitting module 32 penetrates the characteristic assembly body 53 and is output to the outside.

The characteristic assembly body 53 has an assembly convex body 531 for inserting into the characteristic light-transmitting structure 42 to fix the characteristic assembly body 53 to the side panel body 41. The characteristic assembly body 53 protrudes outward relative to the side panel body 41 to present a luminous three-dimensional shape.

Referring to FIG. 12, which illustrate an electronic device with light-emitting structure according to a seventh embodiment of the present invention. The seventh embodiment is substantially the same as the sixth embodiment. The difference is that the light guide body 51 further includes a side light guide component 512 connected to the top light guide component 511.

The characteristic assembly body 53 inserted into the characteristic light-transmitting structure 42 is connected to the light guide body 51. The light emitted by the light-emitting module 32 enters the side light guide component 512 and then enters the characteristic assembly body 53, so that the characteristic assembly body 53 emits light as a whole.

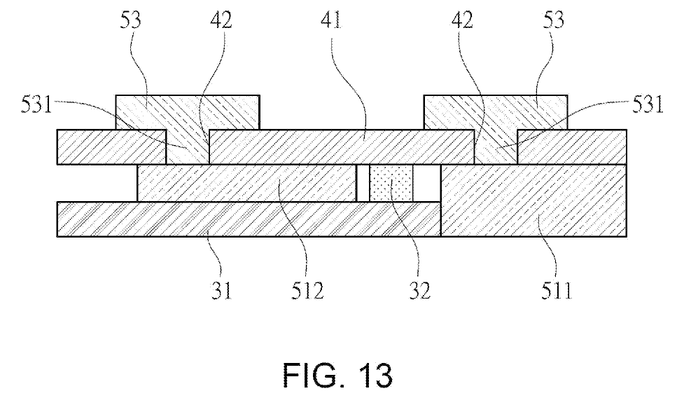

Referring to FIG. 13, which illustrate an electronic device with light-emitting structure according to an eighth embodiment of the present invention. The eighth embodiment is substantially the same as the seventh embodiment. The difference is that the top light guide component 511 and the side light guide component 512 are spaced apart from each other.

The light emitted by the light emitting module 32 can pass through the top light guide component 511 or the side light guide component 512, entering the characteristic assembly body 53 to pass out to the outside. In addition, the light also can pass out through the top of the electronic device with light emitting structure.

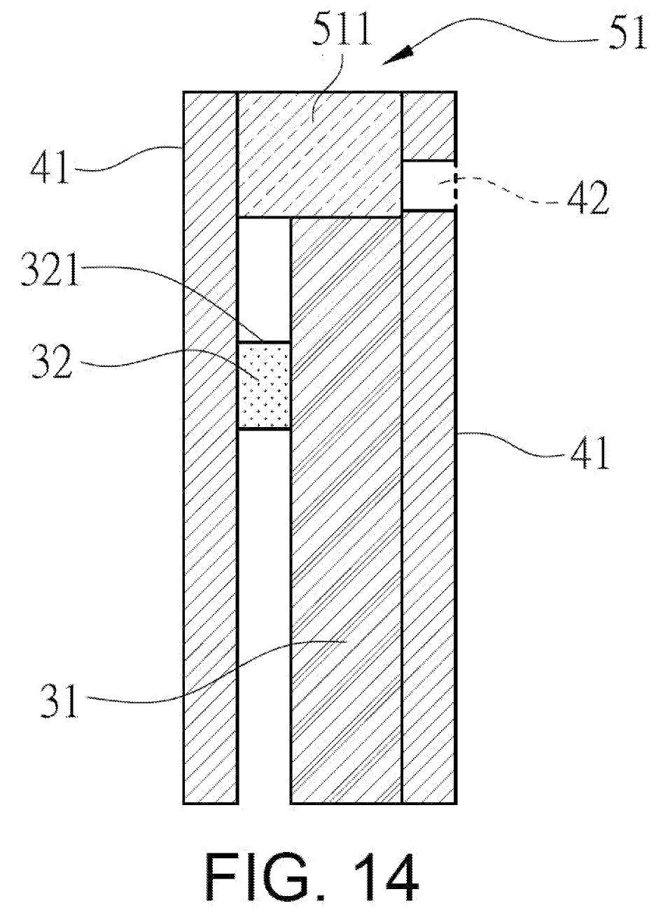

Referring to FIG. 14, which illustrate an electronic device with light-emitting structure according to a ninth embodiment of the present invention. The ninth embodiment is substantially the same as the second embodiment. The difference is that the light-emitting module 32 and the characteristic light-transmitting structure 42 are arranged on opposite sides of the circuit board 31, and the light guide body 51 is arranged between the light-emitting module 32 and the characteristic light-transmitting

The light emitting surface 321 of the light emitting module 32 faces the top light guide component 511. After the light emitted by the light emitting module 32 enters the light guide body 51, it will be reflected in the light guide body 51 to the characteristic light-transmitting structure 42, and then pass through the characteristic light-transmitting structure 42 to be transmitted outward.

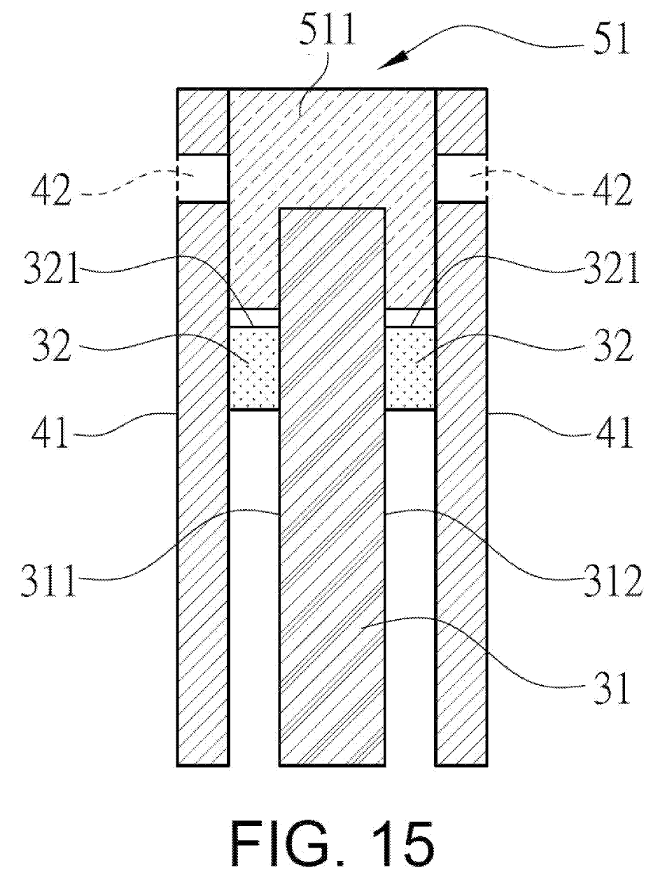

Referring to FIG. 15, which illustrate an electronic device with light-emitting structure according to a tenth embodiment of the present invention. The tenth embodiment is substantially the same as the second embodiment. The difference is that a light-emitting module 32 is arranged on the first surface 311, and another light-emitting module 32 is arranged on the second surface 312. The cross-sectional structure of the light guide body 51 is roughly an inverted U shape.

The light-emitting surfaces 321 of the two light-emitting modules 32 are respectively facing the light guide body 51, so that the light emitted by the light-emitting modules 32 can enter the light guide body 51. The light guide body 51 is connected to two characteristic light-transmitting structures 42, and the light inside the light guide body 51 penetrates the two characteristic light-transmitting structures 42 and passes out.

From the above description, it can be understood that the present invention has the following features:
1. Emitting light from the plate body;
2. Enhancing the vividness of patterns; and
3. Presenting a three-dimensional light-emitting structure.

We claim:

1. An electronic device with light-emitting structure, comprising:
a circuit unit (3) comprising a circuit board (31) and a light-emitting module (32) arranged on the circuit board (31); and
a side panel unit (4) comprising a side panel body (41) arranged on the side of the circuit board (31), and a characteristic light-transmitting structure (42) arranged on the side panel body (41), the light emitted by the light-emitting module (32) penetrating the characteristic light-transmitting structure (42) and being output outward.

2. The electronic device with light-emitting structure as claimed in claim 1, further comprises a light guiding unit (5), the light guide unit (5) comprises a light guide body (51) arranged between the light-emitting module (32) and the characteristic light-transmitting structure (42), and the light emitting surface (321) of the light emitting module (32) faces the characteristic light-transmitting structure (42).

3. The electronic device with light-emitting structure as claimed in claim 2, wherein the light guide unit (5) further comprises a light concentrating structure (52) arranged in the light guide body (51), the light concentrating structure (52) is arranged at a position corresponding to the characteristic light-transmitting structure (42) selected from a convex lens, a concave lens, a Fresnel thread lens, a groove, a perforation, a reflective layer, or a combination thereof.

4. The electronic device with light-emitting structure as claimed in claim 2, wherein the light guide body (51) is arranged on the top and/or side of the circuit board (31).

5. The electronic device with light-emitting structure as claimed in claim 1, further comprises a light guide unit (5), the light guide unit (5) further comprises a characteristic assembly body (53) which is detachably connected to the characteristic light-transmitting structure (42), and the light emitted by the light-emitting module (32) penetrates the characteristic assembly body (53) and is output to the outside.

6. The electronic device with light-emitting structure as claimed in claim 1, wherein the circuit unit (3) further includes a light control module (34) arranged on the circuit board (31).

7. The electronic device with light-emitting structure as claimed in claim 1, wherein the characteristic light-transmitting structure (42) has a light-transmitting hole (421) arranged on the side panel body (41).

8. The electronic device with light-emitting structure as claimed in claim 1, wherein the characteristic light-transmitting structure (42) has a plurality of light-transmitting holes (421) arranged on the side panel body (41), and the apertures of the plurality of light-transmitting holes are consistent.

9. The electronic device with light-emitting structure as claimed in claim 1, wherein the characteristic light-transmitting structure (42) has a plurality of light-transmitting holes (421) arranged on the side panel body (41), and the apertures of the plurality of light-transmitting holes are inconsistent.

10. The electronic device with light-emitting structure as claimed in claim 1, wherein the circuit unit (3) further includes a memory (33) arranged on the circuit board (31).
